(19) United States
(12) Patent Application Publication
(10) Pub. No.: US 2011/0285105 A1
(43) Pub. Date: Nov. 24, 2011

(54) Human powered personal transportation device and drive mechanism for same

(76) Inventor: Shane Chen, Camas, WA (US)

(21) Appl. No.: 13/111,866

(22) Filed: May 19, 2011

Related U.S. Application Data
(60) Provisional application No. 61/346,855, filed on May 20, 2010.

(51) Int. Cl. B62M 1/00

(52) U.S. Cl. 280/220

(57) ABSTRACT

A human-powered personal transportation device powered by pedals which are operated by the user with a stepping motion. The bottom surfaces of the pedals are curved, and serve to guide cable means which transfer the downward stepping force into torque on a rear drive wheel. The curvature of the bottom surface of the pedals is such that the rearmost point of contact between each pedal and its respective cable means is dependent upon the position of the pedal. This causes a variable distance between said rearmost point of contact and the axle of the drive wheel, which translates to variable torque. Thus the continuous transmission functionality is a natural result of the curved pedals.

### CROSS-REFERENCE TO RELATED APPLICATIONS

This application claims the benefit of provisional patent application No. 61/346,855 filed on 2010 May 20 by the present inventor.

### FIELD OF THE INVENTION

The present invention relates to two-wheeled personal transportation devices powered by a stepping stroke and to drive mechanisms for these devices having transmission means, in particular those not requiring the changing of gears.

### BACKGROUND OF THE INVENTION

There are various examples in the prior art of personal transportation devices powered by a stepping stroke, usually by a standing user. (This is as an alternative to the more conventional circular-pedaling bicycles designed to be used while sitting.) These “step scooters” may have gear transmission similar to those used in bicycles; however, there exists the potential for other transmission mechanisms specially adapted to step scooters that may provide advantages in simplicity of manufacture and maintenance and ease of use. Namely, there are possible means for achieving the transmission function without requiring the changing of gears.

One example of such a transmission mechanism is shown in patent application Ser. No. 12/095,616 by Buchberger et al., wherein a spiral-shaped (or otherwise variable-radius) element associated with the axle of the driving wheel allows for a configuration in which each stepping pedals exerts varying degrees of torque upon the driving wheel depending on the pedal's position along its range of motion.

### SUMMARY

The present invention presents a new mechanism for a continuous transmission means in a step scooter. The key feature of the present invention is curvature of the bottom surfaces of the stepping pedals. Cables run along the bottom surfaces of the pedals and extend to a drive wheel, where they wrap around the drive wheel's axle and transfer the force of the step stroke to the wheel. The curved pedals cause the ratio of the step stroke distance to the amount of rotation through which the wheel is driven to be variable dependent upon the pedal's position.

This transmission mechanism allows for a gradual change in torque through a wide range of speeds. The fact that the variable torque is achieved as a natural consequence of the shape of the pedals gives the device of the present invention an advantage of simplicity over the prior art.

### DRAWINGS

### Brief Description of Figures

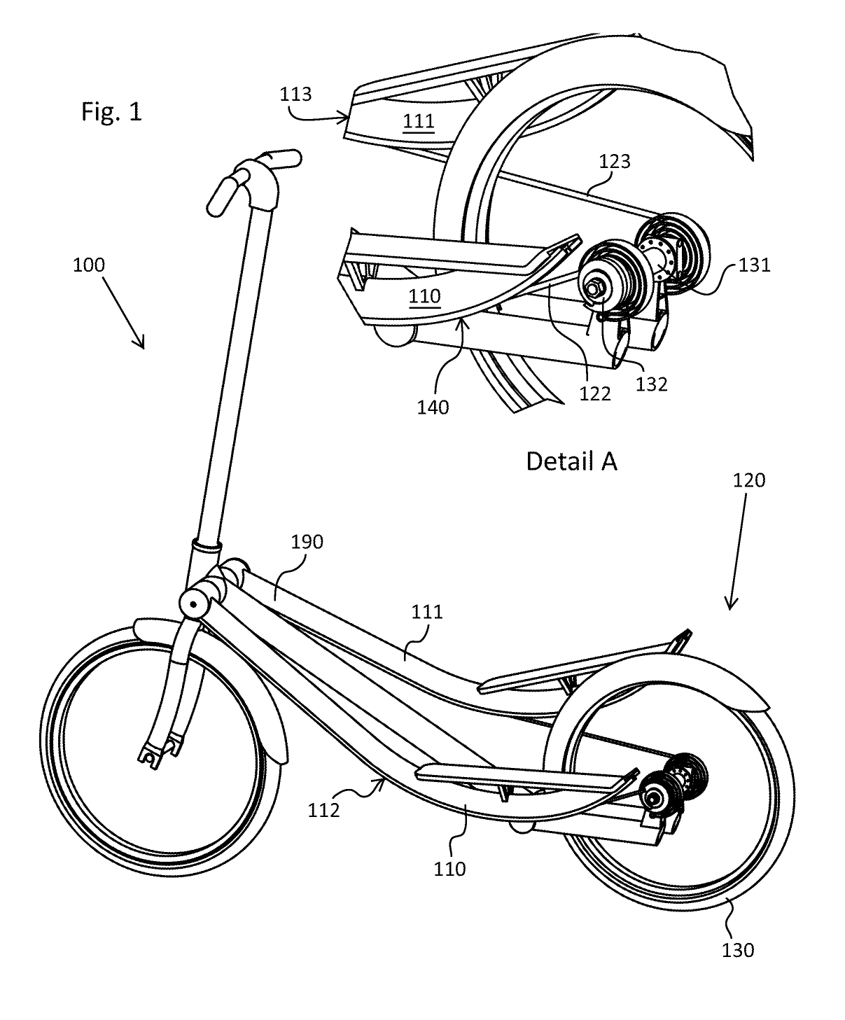

Referring to FIG. 1, a perspective view of a human powered personal transportation device in accordance with the present invention is shown. Detail A shows a closer perspective view of the drive mechanism.

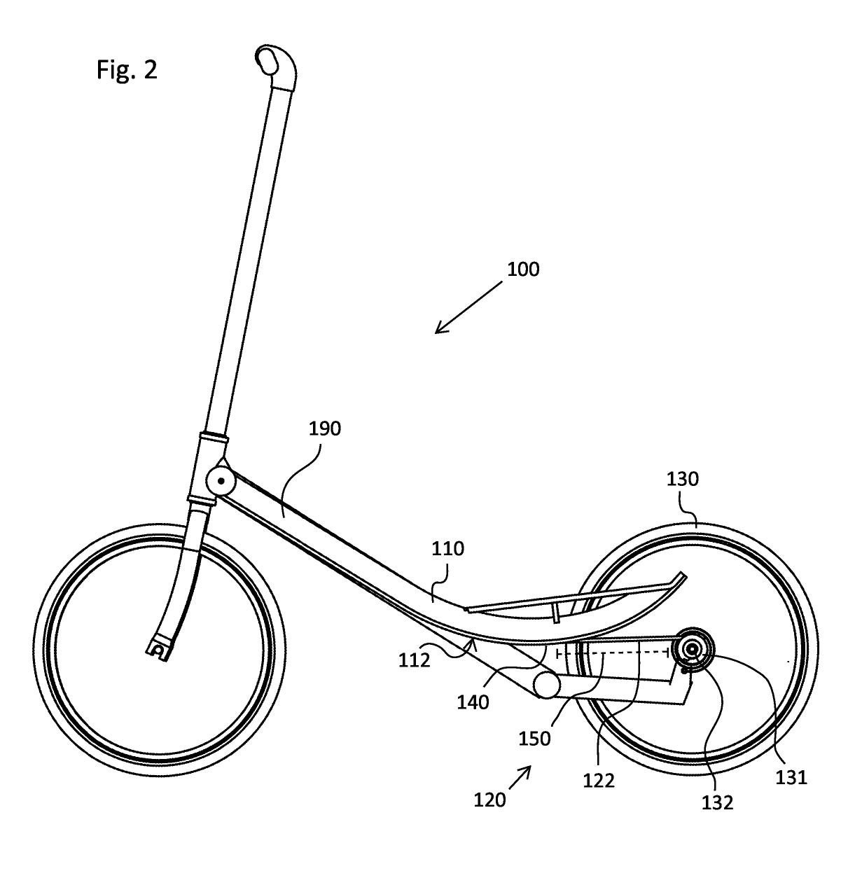

Referring to FIG. 2, a side elevational view of the device of FIG. 1 is shown, wherein some elements not essential to explaining the functioning of drive mechanism 120 have been removed for clarity.

DRAWINGS-List of Reference Numerals

| | |
|---|---|
| 100 | Vehicle |
| 110 | Left pedal |
| 111 | Right pedal |
| 112 | Track (left) |
| 113 | Track (right) |
| 120 | Drive mechanism |
| 122 | Left drive line |
| 123 | Right drive line |
| 130 | Drive wheel |
| 131 | Drive axle |
| 132 | One-way bearing |
| 140 | Rearmost pt. of contact between 110 |
| | and 122 |
| 150 | Distance from 140 to 131 |
| 190 | Frame |

### DETAILED DESCRIPTION

Referring to FIG. 1, a perspective view of a human powered personal transportation device (vehicle) 100 in accordance with the present invention is shown. Detail A shows a closer perspective view of drive mechanism 120. Referring to FIG. 2, a side elevational view of the human powered personal transportation device of FIG. 1 is shown, where some elements not essential to explaining the functioning of drive mechanism 120 have been removed for clarity.

Vehicle 100 comprises pedals 110 and 111, an arrangement of wheels, a drive mechanism 120, and a frame 190 to which all of these may be coupled. Vehicle 100 may further comprise steering handlebars and other elements known in the art of bicycles and step scooters, such as brakes, a kickstand, etc. The arrangement of wheels in the present embodiment consists of a front wheel and a drive wheel 130 in the rear. Pedals 110 and 111 are capable of supporting a human user's feet, and are movably coupled to a forward portion of frame 190 such that they may be pressed downward by the user's weight. The pedals may be elongated members disposed in a direction generally similar to the direction of travel of vehicle 100. Each of pedals 110 and 111 has a curved bottom surface in contact with its respective drive line 122 or 123. In the present embodiment a flat surface in the form of a foot platform is mounted on each of the curved pedals to comfortably support the user's feet.

Pedals 110 and 111 are functionally linked to drive wheel 130 by drive mechanism 120. Drive mechanism 120 comprises drive axle 131 which supports drive wheel 130, and drive lines 122 and 123, which are independently capable of engaging drive axle 131 through a one-way bearing 132 (sometimes known as a “freewheel”) and which are respectively strung beneath pedals 110 and 111. Implementation of drive lines 122 and 123 may be accomplished in a variety of ways, including as straps or belts (as shown in FIGS. 1 and 2), as chains, or by other flexible cord-like means. Drive mechanism 120 further comprises a means for extending and retracting drive lines 122 and 123 corresponding to changes in position of pedals 110 and 111. For instance, in the present embodiment drive lines 122 and 123 are wrapped around drive axle 131, which extends slightly beyond drive wheel 130 on the left and right sides; drive lines 122 and 123 unwrap as pedals 110 and 111 are pressed downward and rewrap while the pedals return to their original positions. A track 112 or 113 is provided in the curved bottom surface of each of pedals 110 and 111 for receiving and guiding the portion of drive line 122 or 123 that is in contact with the pedal. When the user shifts his or her weight to one of pedals 110 and 111, the pedal is displaced downward, pulling drive line 122 or 123, which exerts torque on drive axle 131 (in the direction of non-free spin of one-way bearing 132) and causes wheel 130 to turn, thereby propelling vehicle 100 forward. When weight is subsequently removed from pedal 110 or 111, one-way bearing 132 allows drive line 122 or 123 to retract freely without affecting the spinning of wheel 130. Drive mechanism 120 may further comprise a bias means for returning pedals 110 and 111 to their original positions when weight is removed from them. The most conventional method for continuously propelling the vehicle is for the user to alternately shift his or her weight to pedals 110 and 111 in a “stepping” motion. Drive mechanism 120 may be configured such that one full step stroke of one of pedals 110 or 111 corresponds to more than one driven rotation of drive wheel 130.

The following description of the action of pedal 110, drive line 122, and track 112 on the left side of vehicle 100 applies identically to pedal 111, drive line 123, and track 113 on the right side. Due to the curvature of the bottom surface of pedal 110, the rearmost point of contact between pedal 110 and drive line 122 (point 140) depends on the height of pedal 110 relative to drive axle 131. As pedal 110 is downwardly displaced by the user's weight, point 140 moves farther rearward, the distance from point 140 to drive axle 131 (distance 150) decreases, and consequently the length of the pedal stroke required to turn drive axle 131 by a given amount decreases. Thus the curvature of pedals 110 and 111, by creating a variable ratio of pedal displacement to torque, effects a continuous transmission mechanism. Furthermore, whenever more torque is required (e.g. mounting a slope), the increased resistance to pressing pedals 110 and 111 into the lower end of their range of motion causes pedals 110 and 111 to move higher; and when less torque is needed (e.g. maintaining a high speed on flat ground), the lack of resistance at the high end causes pedals 110 and 111 to drop lower. Since these changes in average pedal height will generally take place without any deliberate adjustment on the part of the user, the speed change is not only continuous but also automatic.

1. A human powered personal transportation device comprising:
an arrangement of wheels wherein at least one of said wheels is a rear drive wheel supported by a drive axle;
a frame to which said drive axle is coupled;
a first pedal and a second pedal capable of supporting a human user's feet, said pedals being movably attached to said frame, wherein the bottom surface of each of said first and second pedals is curved; and
a first and a second drive line capable of engaging said drive axle;
wherein each of said first and second drive lines is attached to its respective pedal, and each pedal is provided with a means for guiding the portion of said drive line in contact with said pedal;
and wherein said curvature of said bottom surface of each of said pedals is such that the distance from said drive axle to the rearmost point of contact between said drive line and its respective pedal varies with the height of said pedal.

2. The human powered personal transportation device of claim 1, further comprising a means for retracting and extending said first and second drive lines during movement of said first and second pedals such that said drive lines remain taut.

3. The human powered personal transportation device of claim 2, wherein said means for retracting and extending said first and second drive lines comprises a means for wrapping each of said drive lines around said drive axle.

4. The human powered personal transportation device of claim 2, wherein said means for retracting and extending said first and second drive lines comprises a means for receiving each of said drive lines via pulleys.

5. The human powered personal transportation device of claim 1, further comprising a means for biasing said first and second pedals to a position to the highest point in their range of motion.
